(19) United States
(12) Patent Application Publication
(10) Pub. No.: US 2015/0066657 A1
(43) Pub. Date: Mar. 5, 2015

(54) METHOD FOR TAGGING AND DISPLAYING IMAGE DATA

(71) Applicant: HomeAdvisor, Inc., Golden, CO (US)

(72) Inventors: Christopher Steven Terrill, Denver, CO (US); David Paul Zeckser, Denver, CO (US)

(73) Assignee: HomeAdvisor, Inc., Golden, CO (US)

(21) Appl. No.: 14/013,820

(22) Filed: Aug. 29, 2013

(51) Int. Cl. G06Q 30/02; G06Q 30/06

(52) U.S. Cl. CPC G06Q 30/0273; G06Q 30/0623
USPC 705/14.69

(57) ABSTRACT

A method for tagging and displaying image data. A digital image is initially tagged with a plurality of tags to generate a tagged image. Each of the tags includes metadata associated with a corresponding item shown in the image. The tagged image is then displayed on a web browser, and a when a user selects the displayed tagged image, each of the tags is displayed proximate the corresponding item in the tagged image. In response to selecting one of the displayed tags, one or more items similar to the item corresponding to the selected tag are displayed. The item corresponding to the selected tag is then stored in a list, and an advertiser of the selected item is charged in accordance with a predetermined schedule.

### BACKGROUND AND STATEMENT OF THE PROBLEM

Currently, homeowners planning a home improvement or remodeling project may look at photos online of inspiring interior and exterior spaces (kitchens, bathrooms, outdoor patios, etc). While it is easy to find and browse these photos, often homeowners cannot learn key details about the items in those photos, such as materials used, price to build, square footage of the space, or time required to build. Furthermore, even if a photo caption or description provides some of these details, the data is not presented to the homeowner is a structured way, and the homeowner cannot quickly determine products or materials similar to those displayed in the photo.

### SUMMARY AND SOLUTION

The presently described system and method provides a home improvement photo data taxonomy to account for information such as: interior and exterior residential spaces, design styles, materials used in construction, colors, prices, square footage, time to build, and other types of data. This taxonomy is used to capture data on photos, store the data in a data repository, and then provide that data back to a viewer. Furthermore, various brands are allowed to target advertising based on the specific tags in a photo. For example, if a photo contains maple cabinets in a kitchen, the present system allows brands that sell similar cabinets to advertise their product to a user who views that photo.

In one embodiment, a digital image is initially tagged with a plurality of tags to generate a tagged image. Each of the tags includes metadata associated with a corresponding item shown in the image. The tagged image is then displayed on a web browser, and a when a user selects the displayed tagged image, each of the tags is displayed proximate the corresponding item in the tagged image. In response to selecting one of the displayed tags, one or more items similar to the item corresponding to the selected tag are displayed. The item corresponding to the selected tag is then stored in a list, and an advertiser of the selected item is charged in accordance with a predetermined schedule.

### BRIEF DESCRIPTION OF THE DRAWINGS

FIG. 1 is a system diagram showing an exemplary computer system for carrying out the present method;

FIG. 2A is a flowchart showing an exemplary set of steps performed in one embodiment of the present method;

FIG. 2B is a flowchart showing, in greater detail, an exemplary set of steps performed in tagging a photo, in step 201 of FIG. 2A;

FIG. 2C is a diagram of an exemplary exchange of information between a user web browser and a system website in a photo tagging procedure corresponding to the steps shown in FIG. 2B;

FIG. 2D shows the contents of an exemplary tag;

FIG. 3A shows an exemplary user browser screen displaying an initial web page showing a photograph of room including various items;

FIGS. 3B and 3C are diagrams of an exemplary user browser screen showing tag information and corresponding items in one embodiment; and

FIGS. 4A and 4B are diagrams of an exemplary user browser screen showing tag information and corresponding items in an alternative embodiment.

### DETAILED DESCRIPTION

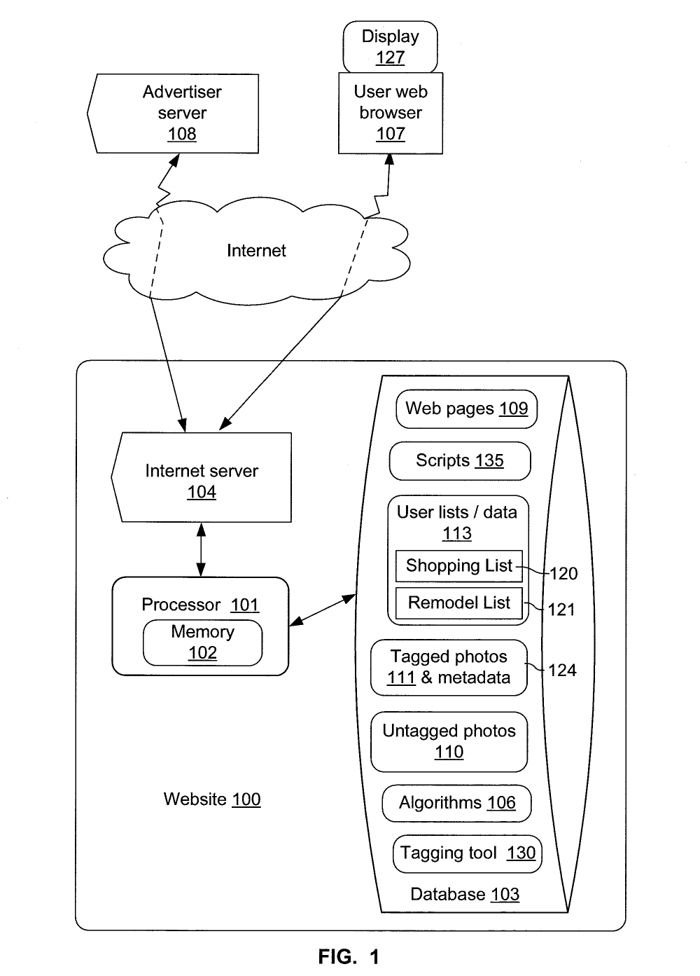

FIG. 1 is a system diagram showing an exemplary computer processing system 100 for carrying out the present method. As shown in FIG. 1, one embodiment the present system for tagging photographic or other image data includes a website 100 comprising a processor 101 and local memory 102 coupled to a database 103 and an Internet server 104. Database 103 contains software algorithms 106 for tagging photographs or other digital images with metadata, and for displaying web pages on an Internet web browser in accordance with the method set forth herein. The database may also contain untagged photographs and/or other digital images 110, tagged photographs and/or other digital images 111, web pages 109, and additional data 113, such as user shopping list 120 and remodel list 121. Processor 101 and database 103 may be integrated into server 104.

Internet server or other network communications device 104 allows system communication with user web browser 107 via the Internet. In system operation, algorithms 106 are loaded into memory 102 and executed by processor 101. Links to various vendor's product information servers 108 are provided by the system to user browser 107 on web pages 109 viewed on an associated display 127. The links on the web pages 109 may be clicked on by a user to provide requested information via a corresponding vendor server 108.

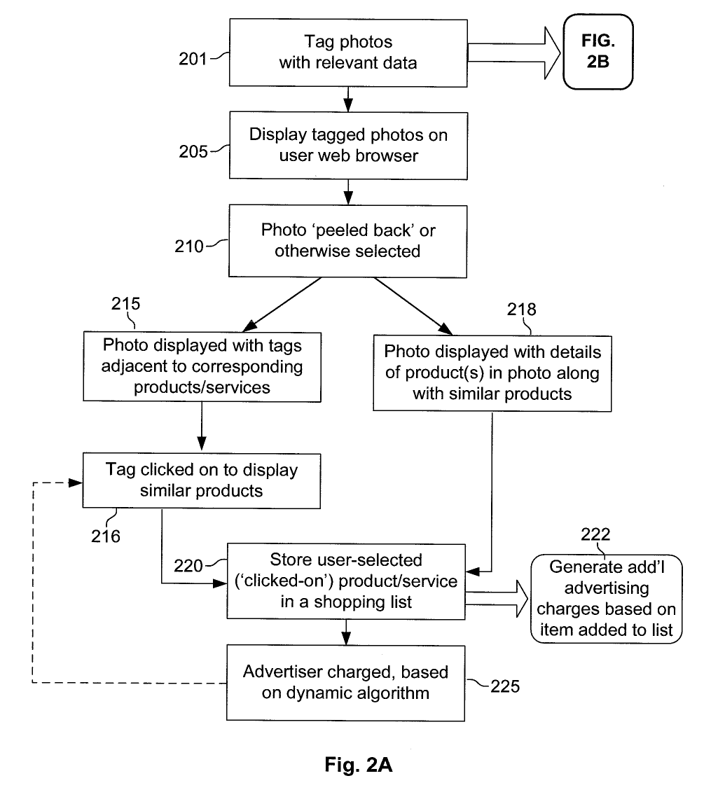

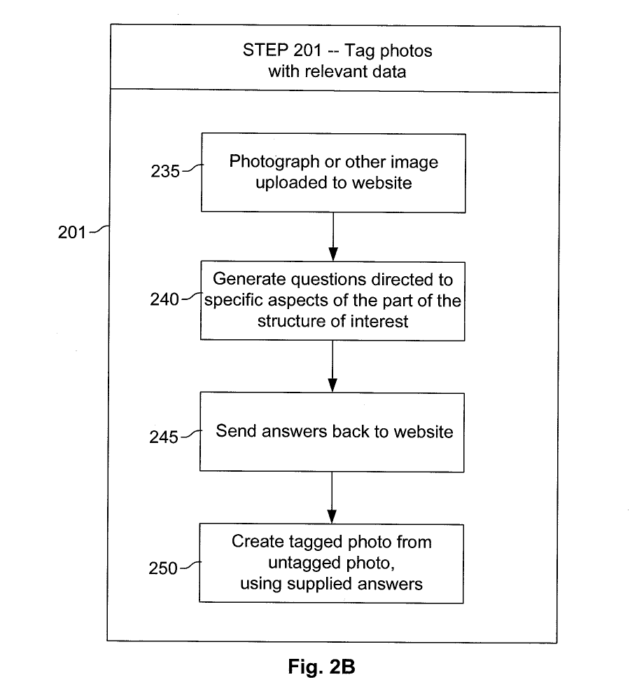

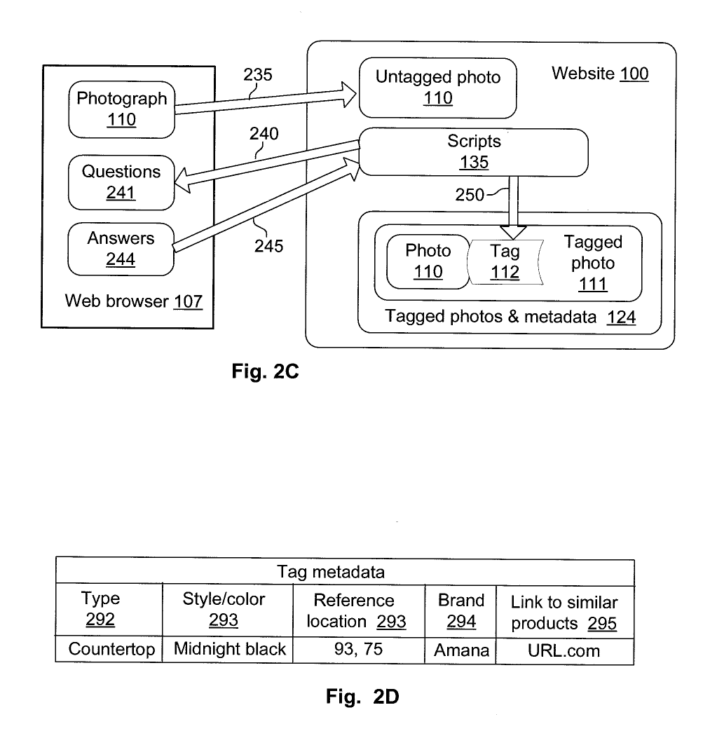

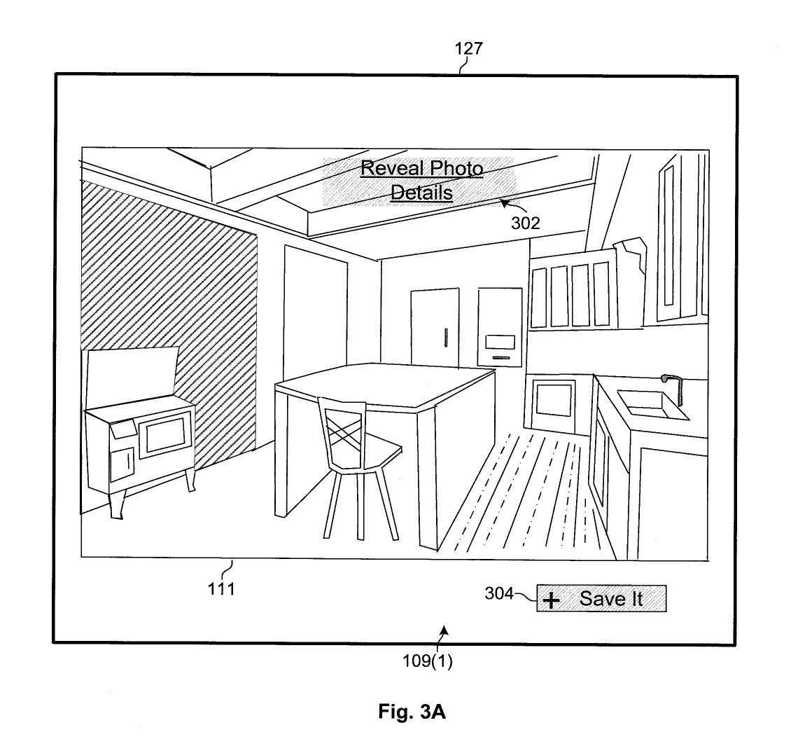

FIG. 2A is a flowchart showing an exemplary set of steps performed in one embodiment of the present method. The present method initially employs a tagging tool 130 to allow home improvement professionals and homeowners to provide information about the details of a home improvement project depicted in a photograph. For example, a home improvement design or construction expert, or the owner of a home where a home improvement project was recently completed, can provide information about photos they have uploaded.

As shown in FIG. 2A, after a tagging implementer (‘tagger’) has navigated a web browser 107 to website 100, the tagger tags a selected photo with relevant data, at step 201. Initially, the tagger uploads a particular photo 110 to the site, and provides information relating to items in the photo, using an online tagging tool 130, as explained below.

FIG. 2B is a flowchart showing, in greater detail, step 201 of FIG. 2A, in which an exemplary set of steps is performed in tagging a photo 110 by online tagging tool 130. FIG. 2C is a diagram of an exemplary exchange of information between a user web browser 107 and website 100 in a photo tagging procedure corresponding to the steps shown in FIG. 2B. As shown in FIGS. 2B and 2C, after navigating web browser 107 to website 100, a tagging implementer locates a photograph 110 of a room or other area (e.g., bathroom, kitchen, deck) to be tagged with metadata having attributes including style (e.g., modern, traditional), materials (e.g., hardwood, carpet, granite), components (e.g., shower head, faucet), price (e.g., $20K-$30K), square footage (e.g., 50-100 sq ft) and/or time to build (e.g., 3-4 weeks), etc.

At step 235, the tagging implementer uploads photo 110 to website 100, where the photo is stored in database 103 as an untagged photo 110. At step 240, user scripts 135 on website 100 generate a series of questions 241 such as those in the example shown in Table 1 below, some of which are directed to progressively more specific aspects of the part of the house or structure of interest. Questions 241 are displayed via browser 107 on user display 127.

TABLE 1
Example Questions Used for Tagging an Uploaded Photo

```
(a) What type of room or area is shown in the photo?
      Example answer: kitchen
(b) What is the primary design style of the space? (modern, traditional)
      Example answer: modern
(c) What is the approximate square footage of the space in the photo?
      Example answer: 50-100 sq feet
(d) What is the approximate cost to construct this space as depicted in the
photo?
      Example answer: $1000-2000
(e) How long did it take to construct this space?
      Example answer: 2-3 months
(f1) What are specific types of components or materials used in this photo?
      (f1a) Example answer: countertop
            (f2) Follow on question: What is primary material?
            (f2a) Example answer: granite
                  (f3) Follow-on question: What type of granite?
                  (f3a) Example answer: midnight black
(g) Would you like to tag additional items in the photo?
    {If answered I the affirmative, questions (f1)-(g) are repeated for the
additional item in the photo 110. to be tagged.}
```

For each question 241, a set of possible answers 244, predetermined for each question, is displayed in a drop-down list on display 127. For question (a) in Table 1, the set of answers 244 displayed in the drop-down list may include, for example:

Kitchen

Bedroom

Bathroom

Living room

For question (f1) in Table 1, the set of answers 244 displayed in the drop-down list may include, for example:

Floor

Countertop

Sink

Cabinets

For question (f2) in Table 1, the set of answers 244 displayed in the drop-down list may include, for example:

Marble

Tile

Granite

composite

For question (f3) in Table 1, the set of answers 244 displayed in the drop-down list may include, for example:

Dark Grey

Midnight black

Coral

Lime green

In step 245, the tagging implementer selects one of the displayed possible answers for each question and replies by sending each answer back (via browser 107) to the relevant script 135, as shown above. Using the answers 244 selected by the tagging implementer (shown in bold font throughout the present example), tagging tool 130 then creates a ‘tagged photo’ 111 from the untagged photo 110, by adding a corresponding tag 112 to the photo 110 at step 250. A photo 110 is tagged by associating metadata with the photo, using a “tag” 112 containing the metadata, which is determined from answers 244 to questions 241.

An example ‘component’ tag 112, generated in response to the answers 244 in Table 1, includes the following metadata shown in FIG. 2D and Table 2 below:

TABLE 2
Example Component Tag 112 Metadata

Type: countertop
Material: granite
Style/color: midnight black
Location: coordinates relative to a reference point on the image
Brand: Amana
Similar products: link to a web page with links to different brands of
midnight black/granite/counter tops

As can be seen from the selected items in bold font in the examples shown above, component tag 112 is generated from answers in Table 1. FIG. 2D shows the contents of an exemplary tag 112. In the present example, using the Table 1 answers (f1a)-(f3a), i.e., “countertop”, “granite”, and “midnight black”, tagging tool 130 generates corresponding segments of tag 112, specifically, tag type 292=“countertop”, style/color 293=midnight black, reference location coordinates (relative to the photo 110 of interest), brand 294=Amana, and a link 295 to similar products having attributes including “countertop”, “granite”, and “midnight black”, as shown in FIG. 2D.

Multiple tags may be associated with a particular photo 110. Once a photo has been tagged, system users are given fast access to information that would be otherwise impossible to glean about the details of an untagged photo.

Tags 112 that are used for indicating item characteristics, such as materials, components and item colors, are fixed to specific locations on a photograph 110 during the tagging process. Tags 112 may have different colors and optional associated open text descriptions (entered into a message box displayed after the questions 241 above have been answered).

The hierarchical association below is established from answers received during the tagging process. The answers in the Table 1 example generate related data records that are organized in a tree structure, such as that shown in the example in Table 3, below, which shows an example of hierarchical parent/child relationships between various components in a particular photo 111. The information shown in Table 3 is generated from answers 244 and stored in database file 124 along with corresponding tagged photos 111. In the present example, the bold font entries in Table 3 correspond to answers (f1a)-(f3a), i.e., “countertop”, “granite”, and “midnight black”, in Table 1. The information in Table 3 is displayed on the corresponding photo's “more information” or “details” web page 109(3), for example.

TABLE 3
Placement-specific Metadata Example

```
Parent Items - Components, including appliances and fixtures
Cabinets
      Child - cabinet materials
      Cherry
            Grandchild - color/finish
            Cherry in rye
            Paprika
            Saddle
      Maple
      Oak . . .
Countertops (parent)
      Child - countertop materials
      granite
            Grandchild - color/finish
            midnight black
            marbled gray
            marbled pink
      marble
      laminate
Ceiling fan
Flooring
Lighting . . .
```

Tagged photos 111 may also be resized. Ratios are used to determine where a tag should be placed when a photo is resized. For example, assume an initial image is 1000×500 pixels and the text of interest has a reference point (an offset) positioned at pixel coordinates (100, 100) relative to this image. From a percentage standpoint, the reference point is positioned at a location=(10%, 20%) of the original image pixel count offset. Then, if this image were re-sized to, for example, 100×50 pixels, then the resultant location of the text reference point would accordingly be (10, 10), calculated by simply applying the relative percentage factor to the resized photo.

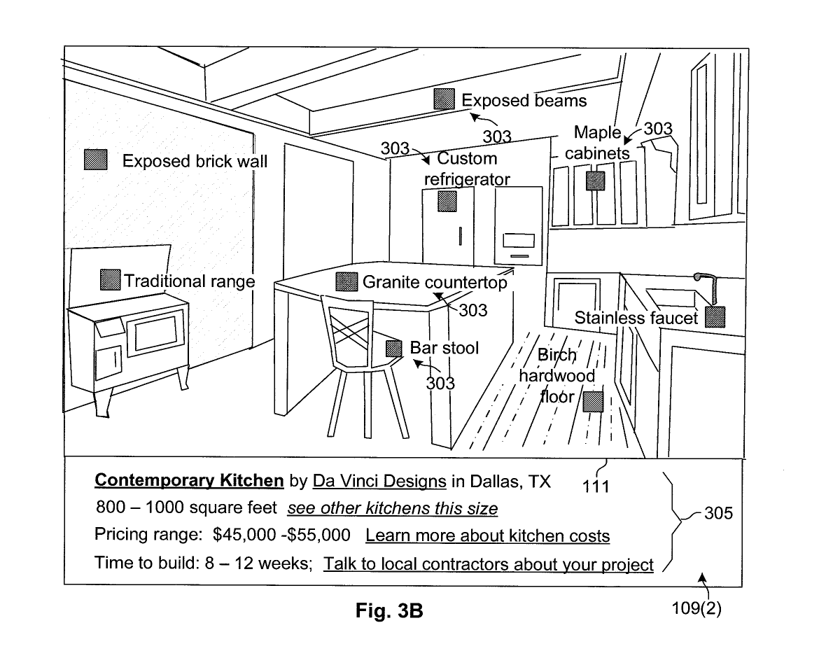

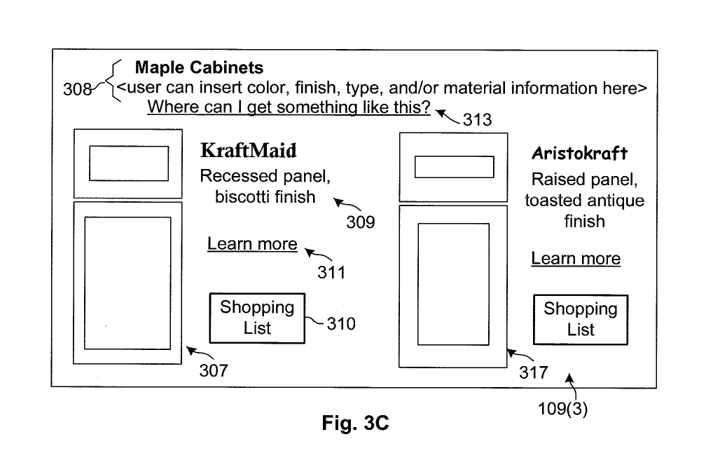

FIG. 3A shows an exemplary user web browser screen 127 displaying an initial web page 109(1). As shown in FIG. 3A, in one embodiment, web page 109(1) includes a tagged photograph or other image 111 depicting a room (a kitchen is shown in the present example) in a house or other structure in or on which is included various items, such as cabinets, flooring, countertops, walls, appliances, furniture, fixtures, and the like. Web page 109(1) includes a link 302 for revealing details about selected items in the photograph 111, and a link 304 for saving the photo in user data area 113.

FIGS. 3B and 3C are diagrams of an exemplary user browser screen 127 showing tag information and corresponding items in one embodiment of the present system. Operation of the present system is best understood by viewing FIGS. 3B, 3C, and the flowchart of FIG. 2A in conjunction with one another.

At step 205, a system user navigates to website 100 and displays a tagged photo 111 on web browser 107. In one embodiment, when a user is viewing a tagged photo 111, as shown in FIG. 3A, they have an option of viewing all of the tagging information associated with the photo (for example, the information in the example of Table 2), by clicking on (selecting) a link 302, at step 210. In response to detecting that link 302 has been selected (by clicking on the link or by ‘peeling back’ the associated image 111), the present system sends web page 109(2) [shown in FIG. 3B] to user browser 107, where the page is displayed on display 127, at step 215.

As shown in FIG. 3B, in one embodiment, web page 109(2) includes labeled tags 303 (i.e., tags 112 that are overlaid on a photo 111) identifying certain items in the photograph 111, each of which is located in proximity to a corresponding item in the photo. Each of the tags in the photo 111 can be clicked on (selected) to see details about a corresponding tagged item. The user can also click on links 305 to see information indicating, and/or links to, the design style, time to build, price to build, etc. At step 216, a user may click on (select) a particular tag 303, in response to which, the system sends a query results web page 109(3) to user browser 107, as shown in FIG. 3C.

In step 216, when a user clicks on, for example, the “Maple cabinets” tag 303 (which contains the “similar products” link 295 shown in FIG. 2D), query results page 109(3) with photos of matching or similar items is sent to user web browser 107. The specific results may be ranked according to the degree to which the clicked-on tag matches the tags in the results photos. For example, a photo that has exactly the same tag components would outrank a photo that is labeled simply “granite countertop”.

Web page 109(3) shows the associated metadata indicating color, finish, type, and/or material 308 for the tagged item, and may also display similar products 307, 317 offered by an alternative brand, manufacturer or retailer, with additional details indicated by text 309, and a link 311 to a web page supplying additional information. In the FIG. 3C example, the displayed Kraftmaid and Aristokraft cabinets are both similar alternatives to the cabinet shown in the original FIG. 3B photo. The type, color, material and/or finish data is collected via the tagging procedure described above. A ‘shopping list’ button 310 on web page 109(3) allows the user to place the associated item in a shopping list 120 for future reference.

At this point, the user may click on link 313 (FIG. 3C), which retrieves a web page (not shown) with information on suppliers of the selected item and similar items. Advertisers may thus target ads based on the tagging metadata used in association with their products. Control flow continues at step 220, described below.

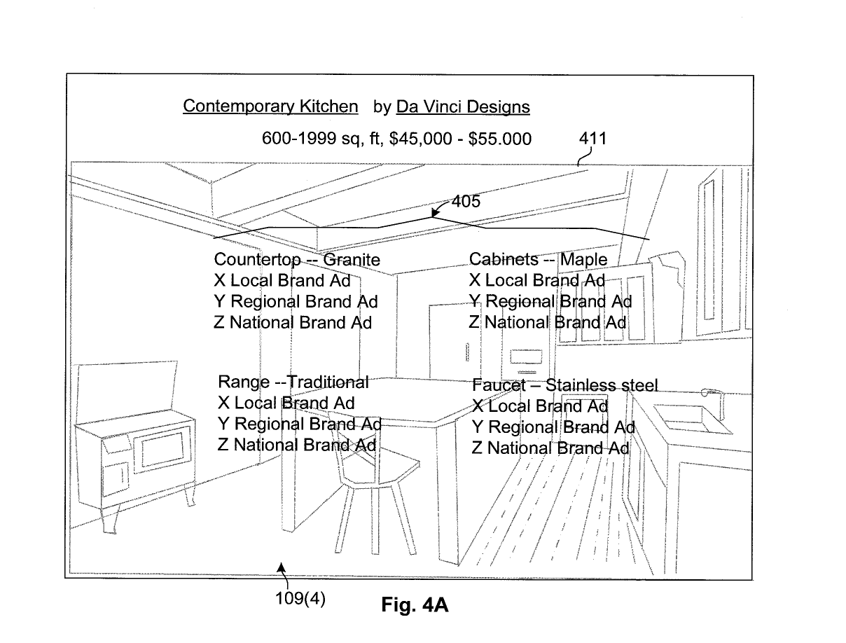

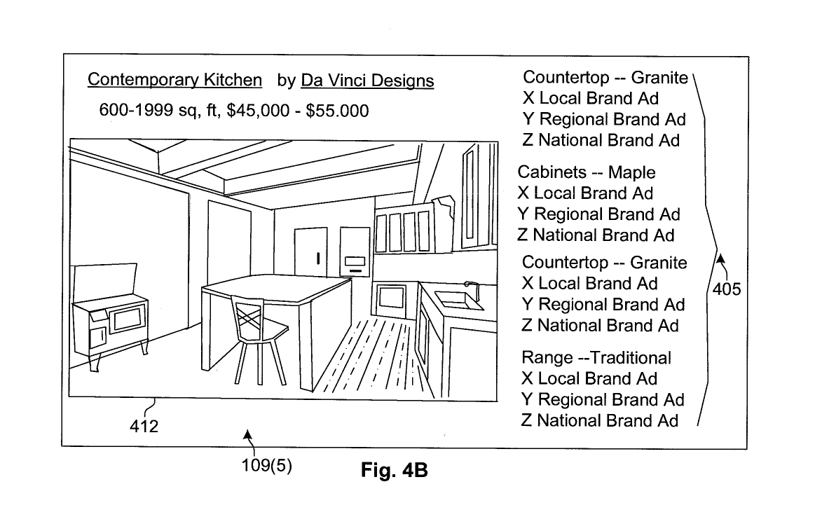

FIGS. 4A and 4B are diagrams of an exemplary user browser screen showing a room (or other area) with information corresponding to certain items in the room, in an alternative embodiment. In this alternative embodiment, at step 210, in response to detecting that link 302 has been selected, the present system sends web page 109(4) (shown in FIG. 4A), or alternatively, web page 109(5) (shown in FIG. 4B), to user browser 107 where the page is displayed on display 127, at step 218. Links 405 on web pages 109(4) and 109(5) are provided to provide advertising related to items in the photos 411/412. The essential difference between web page 109(4) and web page 109(5) is that each advertising link 405 on web page 109(4) is shown adjacent to the related item itself, and on web page 109(5), links 405 are displayed separately from (i.e., not overlaid on) photo 412.

In both embodiments (the embodiment shown in FIGS. 3B/3C and the one shown in FIGS. 4A/4B), at step 220, the user selects one of the displayed tags or links, e.g., tag 303 or link 405, and the user-selected item, either the original product or material, or alternatively, the related alternative product or material that was advertised, is added to the shopping list 120. As the user examines more photos, they may generate a ‘remodel list’ 121 of their favorite products, materials, colors, components, etc., for their own remodel project. This list can be shared with potential contractors during or after a bidding process.

In step 222, the associated advertiser may be optionally charged for each item added to the shopping list 120. In step 225, an advertiser may be charged on the basis of an algorithm which is dynamically based on a predetermined schedule, and which takes into account, for example, the number of impressions/number of times an item is displayed, and/or charged per click-through to a retailer's site where the item can be directly purchased.

Control flow then continues at step 216, where the user can optionally click on another one of the items displayed on the previous web page 109(2) to reveal information about the item.

Certain changes may be made in the above methods and systems without departing from the scope of that which is described herein. It is to be noted that all matter contained in the above description or shown in the accompanying drawings is to be interpreted as illustrative and not in a limiting sense. The elements and steps shown in the present drawings may be modified in accordance with the methods described herein, and the steps shown therein may be sequenced in other configurations without departing from the spirit of the system thus described.

What is claimed is:

1. A method for tagging and displaying image data comprising:
tagging a digital image with a plurality of tags to generate a tagged image wherein each of the tags includes metadata indicating at least one similar product associated with a corresponding item shown in the image;
displaying the tagged image on a web browser;
in response to selecting the displayed tagged image, displaying each of the tags proximate a corresponding item in the tagged image;
displaying, in response to selecting one of the displayed tags, one or more items similar to the item corresponding to the selected tag, as indicated by the metadata;
storing the item corresponding to the selected tag in a list; and
charging an advertiser of the selected item in accordance with a predetermined schedule.

2. The method of claim 1, wherein the advertiser is charged as a function of the number of times an item is displayed.

3. The method of claim 1, wherein the advertiser is charged per click-through to a retailer's site.

4. The method of claim 1, wherein advertising charges are generated based on the item added to the list.

5. The method of claim 1, wherein the metadata includes product information for the item associated with the selected tag, and the product information is displayed on the web browser when the corresponding image is selected.

6. The method of claim 1, wherein the metadata includes attributes indicating one or more of style, materials, components, price, square footage, and time to build.

7. The method of claim 1, wherein the metadata is determined from answers to a predetermined set of questions.

8. A method for tagging and displaying image data comprising:
tagging a digital image with a plurality of tags to generate a tagged image wherein each of the tags includes metadata indicating attributes associated with a corresponding item shown in the image;
displaying the tagged image on a web browser;
in response to selecting the displayed tagged image, displaying, proximate each tagged item in the tagged image, at least some of the metadata associated with the tags;
selecting a tagged item via a link associated therewith;
storing the selected item in a shopping list; and
charging an advertiser of the selected item in accordance with a predetermined schedule.

9. The method of claim 8, wherein the metadata includes product information for the item associated with the selected tag, and the product information is displayed on the web browser when the corresponding image is selected.

10. The method of claim 8, wherein the advertiser is charged as a function of the number of times an item is displayed.

11. The method of claim 8, wherein advertising charges are generated based on the item added to the list.

12. The method of claim 8, wherein the advertiser is charged per click-through to a retailer's site.

13. The method of claim 8, wherein the attributes indicate one or more of style, materials, components, price, square footage, and time to build.

14. The method of claim 8, wherein the metadata is determined from answers to a predetermined set of questions.

15. A method for tagging and displaying image data comprising:
tagging a digital image with a plurality of tags to generate a tagged image wherein each of the tags includes associated metadata indicating attributes corresponding to an item shown in the image, wherein the attributes include the name of at least one product similar to the item;
in response to selecting a tagged image displayed on a web browser, displaying each of the tags proximate a corresponding item in the tagged image; and
displaying, in response to selecting one of the displayed tags, one or more items similar to the item corresponding to the selected tag, as indicated by the metadata.

16. The method of claim 15, wherein the metadata includes product information for the item associated with the selected tag, and the product information is displayed on the web browser when the corresponding image is selected.

17. The method of claim 15, wherein the item corresponding to the selected tag is added to a list, and advertising charges are generated based on the item added to the list.

18. The method of claim 15, wherein an advertiser of the selected item is charged as a function of the number of times an item is displayed.

19. The method of claim 15, wherein an advertiser of the selected item is charged per click-through to a retailer's site.

20. The method of claim 15, wherein the attributes indicate one or more of style, materials, components, price, square footage, and time to build.
